(19) United States
(12) Patent Application Publication
(10) Pub. No.: US 2003/0121371 A1
(43) Pub. Date: Jul. 3, 2003

(54) Ratchet wrench structure

(76) Inventor: Chun-Jung Chiu, Ta Li City (TW)

Correspondence Address: Hart, Baxley, Daniels & Holton, Fifth Floor, 59 John Street, New York, NY, 10038, US

(21) Appl. No.: 10/026,009

(22) Filed: Dec. 27, 2001

(51) Int. Cl. B25B 13/46

(52) U.S. Cl. 81/63.1

(57) ABSTRACT

In a ratchet wrench structure, a fitting sleeve of a sleeve type ratchet wrench is provided with a retaining ball. An elastically movable drive ring is provided externally of the fitting sleeve to control movement of the retaining ball such that an extension sleeve can be quickly assembled to or disengaged from the fitting sleeve. The ratchet wrench thus can adapt to various working environments and can be operated single-handedly to assemble or disengage the extension sleeve and to lock and position the same.

### BACKGROUND OF THE INVENTION

(a) Field of the Invention

The invention relates to a ratchet spanner, and is particularly directed to improving parts of the ratchet wrench which concern assembly and disengagement of sleeves and the tightening and loosening of workpieces.

(b) Description of the Prior Art

Referring to FIG. 1, a unidirectional ratchet is connectedly provided with a fitting post having a retaining ball disposed thereon for retaining a sleeve. The rotating direction of the ratchet is controlled via a swing button. In order to match position and depth of workpieces, sleeves of different lengths and sizes are provided for selection by the operator, which increases costs and may not oftentimes meet actual needs.

Referring to FIG. 2, a polygonal sleeve hole is provided at a working end of a ratchet spanner for receiving a sleeve. The sleeve is provided with a retaining ball at a polygonal coupling end thereof for retaining shallow grooves in the sleeve hole. In addition to the aforesaid drawback, this type of wrench is costly since each sleeve is provided with a retaining ball, and the depth of the groove cannot firmly retain the retaining ball and the sleeve cannot be firmly secured.

Referring to FIG. 3, a ratchet at a working end of a wrench is insertably provided with a retaining ring for retaining and coupling a sleeve with an open top. This sleeve type ratchet wrench permits a workpiece to extend through the sleeve and the wrench to suit more workpiece positions and depths. However, during assembly or disengagement of the sleeve, the operator has to use both hands and apply a relatively large force. Besides, the retaining ring readily wears and becomes deformed. After prolonged use, the retaining ring will suffer from fatigue and result in slippage of the sleeve.

### SUMMARY OF THE INVENTION

The primary object of the invention is to provide a ratchet wrench structure which can be operated single-handedly to assemble and disengage sleeves, which can lock and position sleeves, which can flexible adapt to the position and depth of a workpiece.

Another object of the invention of the invention is to provide a ratchet wrench structure which provides a quick operation function so that the operator can, under the condition that turning of the wrench is not desired, use his fingers to rotate a drive ring at an end portion to tighten or loosen a workpiece, thereby expediting operation.

In order to achieve the aforementioned objects, a sleeve type ratchet wrench includes a fitting sleeve provided with a retaining ball. The fitting sleeve is externally provided with an elastically movable drive ring for controlling movement of the retaining ball such that an extension sleeve can be quickly assembled to or disengaged from the fitting sleeve.

### BRIEF DESCRIPTION OF THE DRAWINGS

The foregoing and other features and advantages of the present invention will be more clearly understood from the following detailed description and the accompanying drawings, in which,

FIG. 1 is an exploded perspective view of a conventional ratchet wrench and a sleeve;

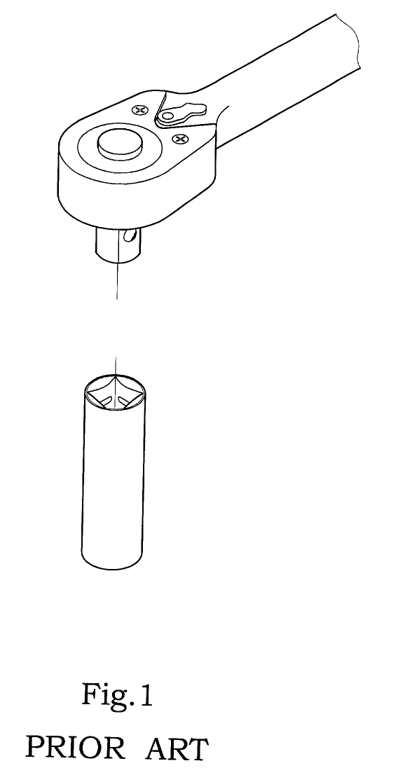

FIG. 2 is a perspective view of another conventional ratchet wrench;

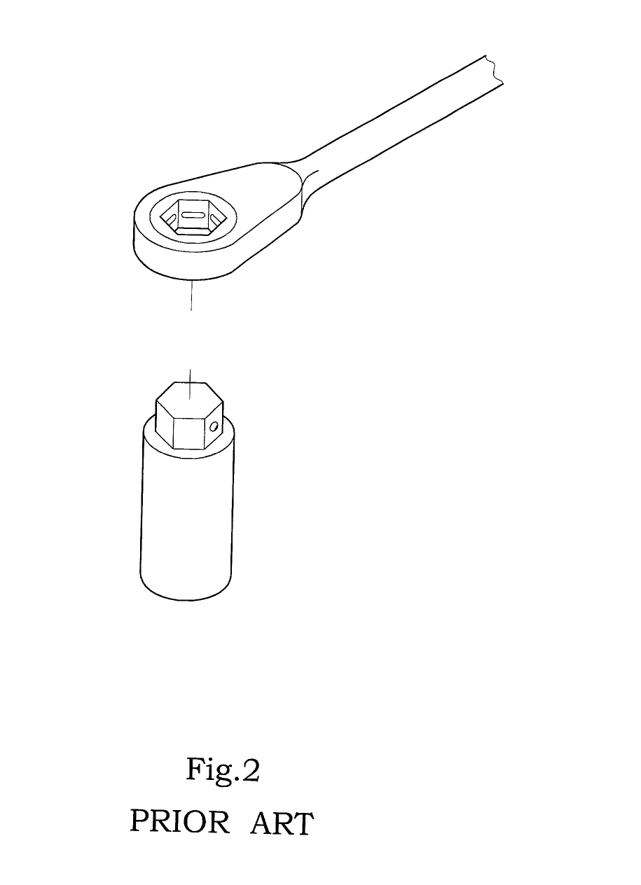

FIG. 3 is a perspective view of a further conventional ratchet wrench;

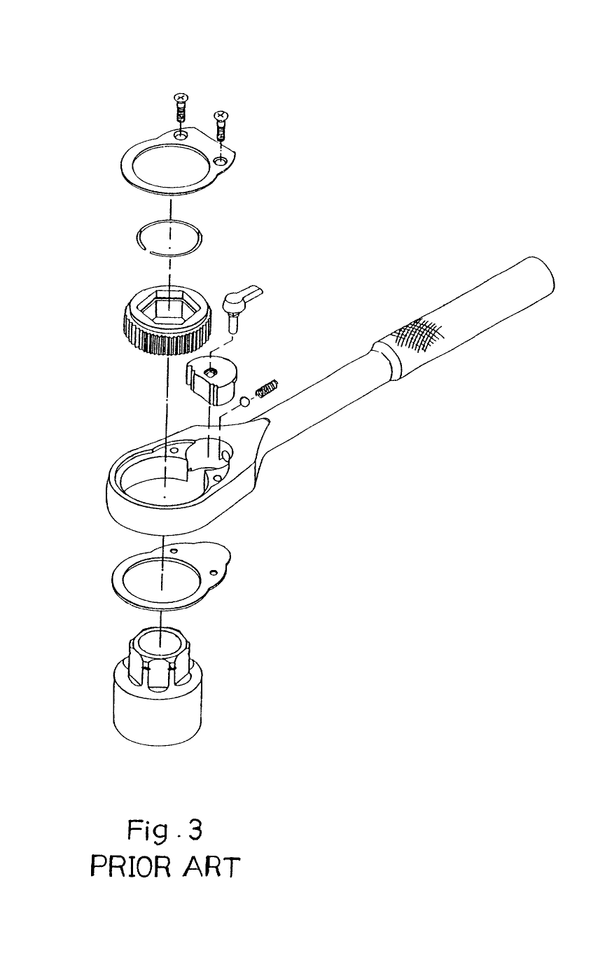

FIG. 4 is an exploded perspective of a ratchet wrench and sleeve according to the invention;

FIG. 5 is a perspective assembled view of the invention;

FIG. 6A is a schematic sectional view illustrating coupling of the sleeve and the wrench according to the invention;

FIG. 6B is another schematic sectional view illustrating coupling of the sleeve and the wrench according to the invention; and

FIG. 7 is a sectional view of FIG. 6A, taken along line 7-7 and the arrows.

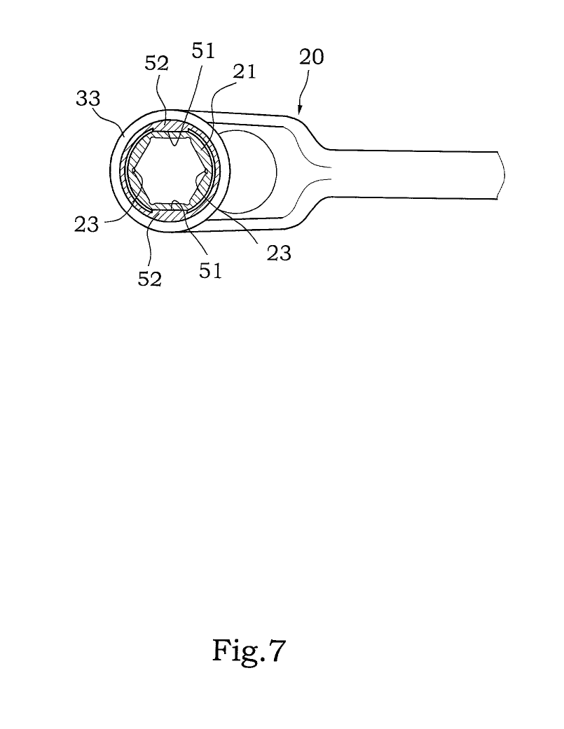

### DETAILED DESCRIPTION OF THE PREFERRED EMBODIMENT

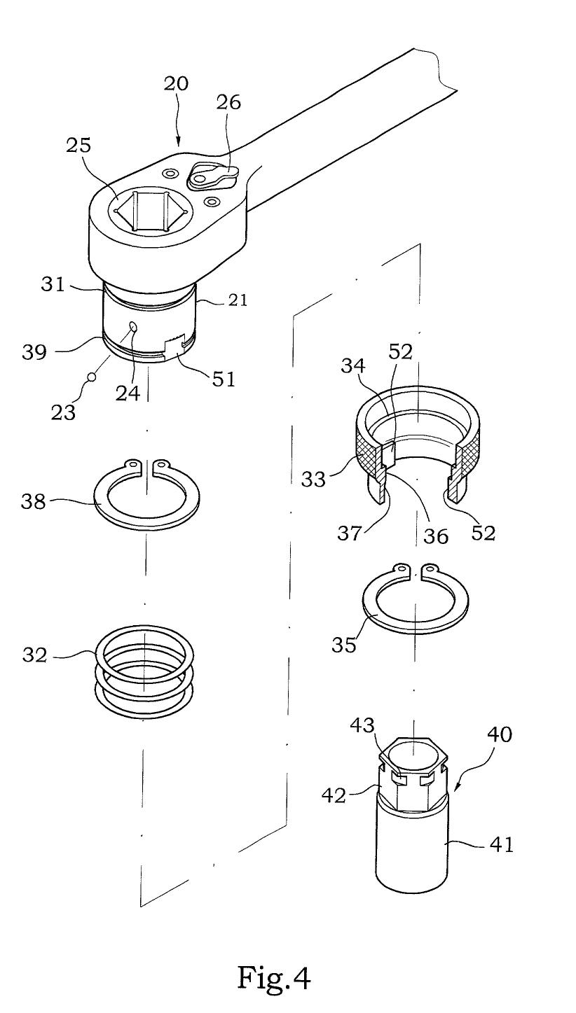

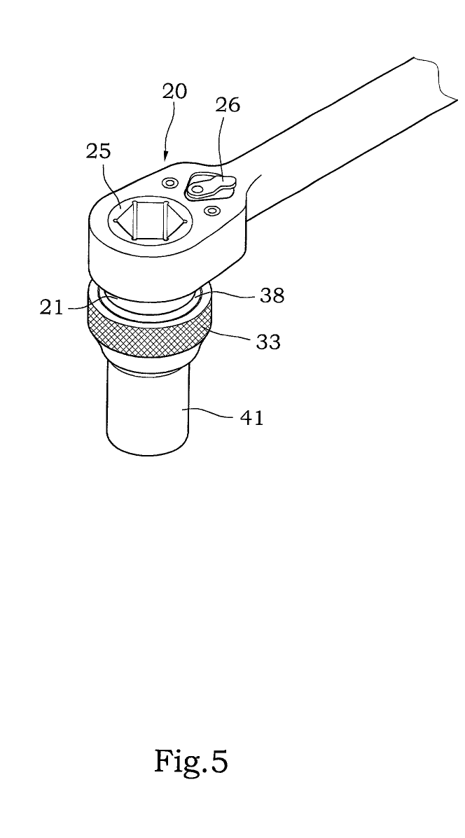

Referring to FIGS. 4 and 5, a ratchet wrench structure according to the invention includes a sleeve type ratchet wrench 20, a drive ring 33, an extension sleeve 40, and a quick operating structure.

The wrench 20 has a working end provided with an angular-hole ratchet device 25, the direction action of which is controlled by a swing button 26. The lower end of the ratchet device 25 is a fitting sleeve 21. The center of the fitting sleeve 21 is a polygonal sleeve hole 22, the wall surface of which is provided with at least one movable type retaining structure. The retaining structure is provided with at least one ball hole 24 in an end wall of the sleeve hole 22. The ball hole 24 has a retaining ball 23 disposed therein.

The drive ring 33 is provided externally of the fitting sleeve 21. A spring 32 is disposed between the drive ring 33 and fitting sleeve 21. A groove 31 is formed in an upper portion of the outer surface of the fitting sleeve 21 for retaining a C-clip 38 for the end portion of the spring 32 to abut against to be thereby positioned. The inner ring surface of the drive ring 33 has an inwardly projecting stop portion 34 for the other end of the spring 32 to abut against. The lower portion of the outer edge of the fitting sleeve 21 is provided with a recess 39 for retaining another C-clip 35 which is stopped at the bottom edge of the drive ring 33. The drive ring 33 can elastically move up and down without slippage due to the spring 32. The projecting vertical wall edge of the stop portion 34 also forms a wedge-shaped push surface 36 for pushing the retaining ball 23 so that a part of the edge surface thereof projects toward the inner wall of the sleeve hole 22. The inner wall of the drive ring 33 that is adjacent to the lower edge of the push surface 36 is provided with an outwardly depressed annular ball surface 37.

The extension sleeve 40 includes a sleeve portion 41 and a coupling portion 42. The coupling portion 42 has a hollow and cylindrical interior and a polygonal outer surface. A retaining groove 43 is provided at each angular corner of the outer surface such that when the extension sleeve 40 is disposed in the sleeve hole 22 of the fitting sleeve 21, the retaining ball 23 projecting from the inner wall of sleeve hole can extend into the retaining groove 43 to thereby secure the extension sleeve 40.

The operating structure includes two planar milled surfaces 51 disposed at opposite positions on the outer surface of the fitting sleeve 21 near the bottom end. The inner edge of the bottom end of the drive ring 33 is provided with planar projecting blocks 52 to correspond to the milled surfaces 51, respectively. The projecting blocks 52 are provided to abut against the milled surfaces 51 such that when the drive ring 33 is rotated by hand, the fitting sleeve 21 and ratchet device 25 can be brought to quickly rotate.

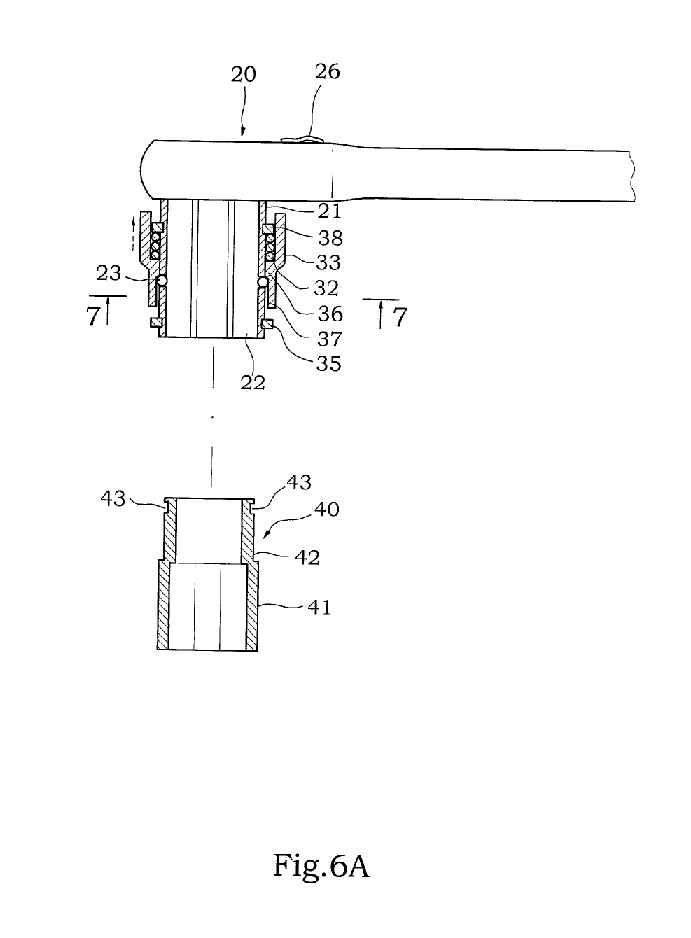

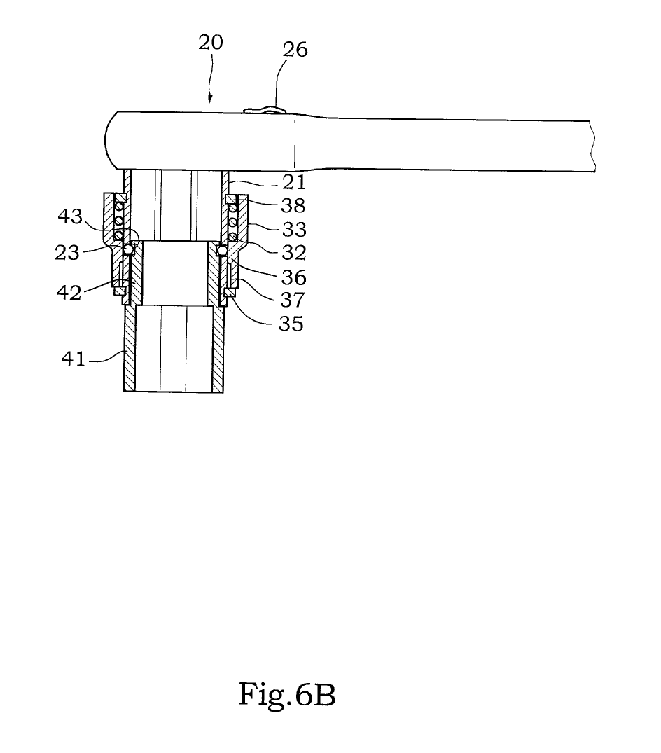

Referring to FIGS. 6A and 6B, when assembling the extension sleeve 40, the drive ring 33 is pushed in the direction of the ratchet wrench 20 so that the depressed annular ball surface 37 therein is aligned with the retaining ball 23 of the fitting sleeve 21. When the extension sleeve 40 is inserted into the sleeve hole 22, it will push the retaining ball 23 to cause it to withdraw and sink into the depressed annular ball surface 37. After the extension sleeve 40 is disposed in the sleeve hole 22 of the fitting sleeve 21, the drive ring 33 is released so that the drive ring 33 resumes its position due to the biasing action of the spring 32. During that process, the wedge-shaped push surface 36 will slidably push the retaining ball 23 so that the retaining ball 23 projects from the wall surface of the sleeve hole 22 so that a part thereof is insertably retained in the retaining groove 43 of the extension sleeve 40, thereby positioning the extension sleeve 40.

Generally speaking, the ratchet wrench is manipulated to move in the operating direction to bring the sleeve and workpiece to rotate, and reverse rotation thereof produces idle rotation to buffer the driving of the ratchet wrench. However, the interval of idle rotation may make the operator feel that the operation process is prolonged, and the operator may not need to use the idle rotation function of the wrench. The quick operating structure of the invention employs the milled surfaces 51 and the projecting blocks 52 to cause the drive ring 33 to bring the fitting sleeve 21 and the ratchet device 25 to quickly rotate, so that the operator can directly rotate the drive ring to tighten or loosen the workpiece without turning the wrench, thereby expediting the operation.

In addition, the present invention has the following advantages:

The ratchet device 25 and the fitting sleeve 21 combine with the extension sleeve 40 to form a sleeve type ratchet wrench to allow the workpiece to extend through the fitting sleeve 21 and the ratchet device 25, thereby flexibly accommodating the position and depth of the workpiece.

The fingers holding the wrench can be used to grip the drive ring 33, and the straightening or bending of the fingers can rotate the drive ring 33 axially, thereby permitting mounting and dismantling of the extension sleeve 40 single handedly in a simple, convenient and quick manner.

When the retaining ball 23 is retained in the retaining groove 43 of the extension sleeve, the extension sleeve 40 is in a locked and secured state. Even the application of an outward pulling force will not disengage the extension sleeve 40. Hence, the extension sleeve 40 will not accidentally slip during operation.

What is claimed is:

1. A ratchet wrench structure, comprising:
an angular-hole ratchet device disposed at an end portion of a handle;
a fitting sleeve disposed at a lower end of said ratchet device, said fitting sleeve being centrally provided with a sleeve hole with a wall surface provided with at least one movable type retaining structure;
a drive ring disposed on an outer surface of said fitting sleeve and capable of axial elastic reciprocating movement along said fitting sleeve without slippage, said drive ring moving in the direction of said ratchet device so that said retaining structure has a space for withdrawal outwardly of said fitting sleeve, said drive ring moving in the direction distal from said ratchet device to cause said retaining structure to project from the wall of said sleeve hole; and
an extension sleeve having one end provided with a plurality of retaining grooves and disposed in said sleeve hole for retaining said retaining structure projecting from said sleeve hole.

2. The ratchet wrench structure as claimed in claim 1, wherein said retaining structure includes at least one ball hole provided in the wall surface of said sleeve hole, said ball hole accommodating a retaining ball.

3. The ratchet wrench structure as claimed in claim 1, wherein a spring is disposed between said drive ring and said fitting sleeve for controlling said drive ring to axially, elastically and reciprocatingly displace along said fitting sleeve.

4. The ratchet wrench structure as claimed in claim 1, wherein the outer surface of said fitting sleeve is provided with a C-clip for abutment by an end portion of said spring, the inner wall of said drive ring being provided with a projecting stop portion for abutment by another end portion of said spring.

5. The ratchet wrench structure as claimed in claim 1, wherein the outer surface of said fitting sleeve near a bottom end thereof is provided with a C-clip for stopping at the bottom edge of said drive ring to prevent slippage of said drive ring.

6. The ratchet wrench structure as claimed in claim 1, wherein the inner wall of said drive ring is provided with a projecting wedge-shaped push surface for pushing said retaining structure toward the interior of said sleeve hole.

7. The ratchet wrench structure as claimed in claim 1, wherein when said drive ring displaces away from said ratchet device, said wedge-shaped push surface pushes said retaining structure toward said sleeve hole from outside so that said retaining structure partly projects from the wall of said sleeve hole.

8. The ratchet wrench structure as claimed in claim 1, wherein the inner wall of said drive ring is provided with a depressed annular ball surface to constitute a space for outward withdrawal of said retaining structure.

9. The ratchet wrench structure as claimed in claim 1, wherein said drive ring moves in the direction of said ratchet device, said depressed annular ball surface corresponding to said retaining structure so that said retaining structure has a space for outward withdrawal toward said fitting sleeve.

10. The ratchet wrench structure as claimed in claim 1, further comprising a quick operating structure.

11. The ratchet wrench structure as claimed in claim 10, wherein said quick operating structure is provided with at least one planar milled surface on the outer surface of said fitting sleeve proximate to the rear end, the inner edge of the bottom edge of said drive ring being provided with a planar projecting block corresponding to said milled surface for abutting against said milled surface so that said drive ring can drive said fitting sleeve.
